(19) United States
(12) Patent Application Publication
(10) Pub. No.: US 2008/0258573 A1
(43) Pub. Date: Oct. 23, 2008

(54) Rotor of Rotating Electric Machine, Rotating Electric Machine and Vehicle Drive Apparatus

(75) Inventor: Munehiro Kamiya, Anjo-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/884,656

(22) PCT Filed: Mar. 6, 2006
(86) PCT No.: PCT/JP06/04826

§ 371 Date: Aug. 20, 2007

(30) Foreign Application Priority Data
Mar. 11, 2005 (JP) 2005-069571

(51) Int. Cl. H02K 21/14; B60K 6/20

(52) U.S. Cl. 310/156.02; 180/65.2

(57) ABSTRACT

There are provided a rotor of a rotating electric machine that can implement high-speed rotations with improved energy efficiency, as well as the rotating electric machine and a vehicle drive apparatus. The rotor of the rotating electric machine includes two magnets arranged within an electrical angle in the range of 127° to 140°, the electrical angle having its center at the center of rotations of the rotor, and the magnets being arranged along a V-shape with its acute end facing toward the center of rotations. The rotor further includes a rotor body having two openings housing the two magnets respectively. The rotor body has a support portion placed at the acute end of the V-shape and serving as a partition between the two openings.

### TECHNICAL FIELD

The present invention relates to a rotor of a rotating electric machine, the rotating electric machine and a vehicle drive apparatus. In particular, the invention relates to a rotor of an interior permanent magnet synchronous motor, a rotating electric machine having the rotor mounted thereon, and a vehicle drive apparatus.

### BACKGROUND ART

Recently, in terms of global warming prevention and resource conservation, the role to be fulfilled by motor vehicles has been considerably increasing in importance. For the motor vehicle, reduction of CO₂ emissions requires improvement in fuel economy. The improvement in fuel economy has to be accomplished together with emissions-cleaning and safety assurance.

As vehicles improved in fuel economy, fuel cell vehicles and hybrid vehicles have been of great interest. The hybrid vehicle includes as its component a gasoline engine, a transmission, an inverter, a battery, a motor as well as their controllers. Such vehicles require a motor that is highly reliable, efficient, variable in rpm and superior in control. One of motors meeting the above-described requirements is an interior permanent magnet synchronous motor (hereinafter IPM motor).

Japanese Patent Laying-Open Nos. 2004-320952 and 2001-251825 each disclose an IPM motor having permanent magnets arranged in the shape of V.

Hybrid vehicles were first implemented as 1.5-liter class compact cars to become commercially practical. In order to promote global warming prevention, the hybrid vehicles are desirably applied to larger-sized cars for improving fuel economy. For example, it is expected that a hybrid system will be developed that can also be adapted for example for large-sized sport utility vehicles (hereinafter SUV) having a 3.3 liter engine. For this purpose, in terms of a balance with respect to the high-power engine, the power density of a vehicle-drive motor has to be improved to a considerable degree.

The motor power density may be enhanced by improving the motor output torque itself or by operating the motor at a high rpm and then reducing the speed by a gear mechanism so as to increase the torque.

FIG. 9 shows a relation between the stator's outer diameter and the motor speed (rpm) of a motor that has been developed as a vehicle motor.

Conventional vehicle motors are represented by points A to F indicated under the line drawn in FIG. 9. While it is advantageous to increase the outer diameter of a rotor as much as possible, the increased outer diameter thereof of the conventional vehicle causes a vehicle drive apparatus to increase in size, which is not preferable.

Therefore, it would be desirable to develop a motor with its stator diameter equivalent to those indicated by points A to D of the conventional vehicle motors while capable of rotating at a high rpm that is at least twice as high as the conventional motors, like the motor represented by point S in FIG. 9. The motor thus developed may be used with its rpm decreased for use so as to implement a hybrid system applicable to the SUV. In this case, the rotor strength against centrifugal force has to be improved as compared with that of the conventional motors.

Regarding the improvement in fuel economy, it is also necessary to take into account losses generated in the motor.

FIG. 10 illustrates distribution of major motor losses.

In FIG. 10, region R1 is a region where the copper loss is larger than the iron loss and region R2 is a region where the iron loss is larger than the copper loss.

The iron loss refers to energy converted into heat in the iron core, which is a magnetic body, when subjected to an alternating magnetic field, due to magnetic hysteresis or eddy current. The copper loss refers to electric power loss due to resistance in coil windings. It is seen from FIG. 10 that the iron loss tends to be larger in the region where the motor rpm is relatively higher.

While the vehicle motor is required to output high power over a wide speed range, the vehicle motor frequently operates in a light-load region in the case of normal operation, for example, normal city driving. In FIG. 10, region R3 represents an operating region where the motor frequently operates in the case of normal city driving. In other words, as shown in FIG. 10, light-load region R3 is substantially included in region R2 where the iron loss ratio is relatively high.

If a motor with a high rpm as indicated by point S in FIG. 9 is implemented, the iron loss will increase, since, in the iron loss, the hysteresis loss is proportional to the motor speed rpm and the eddy-current loss is proportional to the square of the motor speed rpm. Namely, the iron loss increases in proportion to the first power to the square of the motor speed rpm.

In other words, for improving the fuel economy, it is important to improve the fuel economy in the light-load region where the motor frequently operates. If a high rpm motor is used with the purpose of increasing the output power density, influences of the iron loss increase to a considerable degree. Therefore, in order to enhance the output power density and improve fuel economy, any technique suppressing iron losses is important.

### DISCLOSURE OF THE INVENTION

An object of the present invention is to provide a rotor of a rotating electric machine that can implement high-speed rotations together with improved energy efficiency, as well as the rotating electric machine and a vehicle drive apparatus.

In summary, the present invention according to an aspect of the invention is a rotor of a rotating electric machine. The rotor includes: a first magnet and a second magnet arranged within an electrical angle in the range of 127° to 140°, the electrical angle having its center at the center of rotations of the rotor, and the magnets being arranged along a V-shape with its acute end facing toward the center of rotations; and a rotor body having a first opening and a second opening housing the first magnet and the second magnet respectively. The rotor body has a support portion placed at the acute end of the V-shape and serving as a partition between the first opening and the second opening.

Preferably, the rotor is a rotor of an eight-pole interior-magnet synchronous rotating electric machine.

The present invention according to another aspect of the invention is a rotating electric machine. The rotating electric machine includes a stator and a rotor. The rotor includes: a first magnet and a second magnet arranged within an electrical angle in the range of 127° to 140°, the electrical angle having its center at the center of rotations of the rotor, and the magnets being arranged along a V-shape with its acute end facing toward the center of rotations; and a rotor body having a first opening and a second opening housing the first magnet and the second magnet respectively. The rotor body has a support portion placed at the acute end of the V-shape and serving as a partition between the first opening and the second opening.

Preferably, the rotating electric machine is an eight-pole interior-magnet synchronous rotating electric machine.

The present invention according to still another aspect of the invention is a vehicle drive apparatus. The vehicle drive apparatus includes: a first rotating electric machine; a reduction mechanism connected to a rotational shaft of the first rotating electric machine; and an axle rotating according to rotations of the rotational shaft reduced in speed by the reduction mechanism. The first rotating electric machine includes a stator and a rotor. The rotor includes: a first magnet and a second magnet arranged within an electrical angle in the range of 127° to 140°, the electrical angle having its center at the center of rotations of the rotor, and the magnets being arranged along a V-shape with its acute end facing toward the center of rotations; and a rotor body having a first opening and a second opening housing the first magnet and the second magnet respectively. The rotor body has a support portion placed at the acute end of the V-shape and serving as a partition between the first opening and the second opening.

Preferably, the vehicle drive apparatus further includes: an engine; a second rotating electric machine; and a power split device splitting motive power between the reduction mechanism, the engine and the second rotating electric machine. The reduction mechanism has a reduction gear ratio of at least two to one between the first rotating electric machine and the power split device.

The present invention according to a further aspect of the invention is a vehicle drive apparatus. The vehicle drive apparatus includes: a first rotating electric machine; a reduction mechanism connected to a rotational shaft of the first rotating electric machine; an axle rotating according to rotations of the rotational shaft reduced in speed by the reduction mechanism; an engine; a second rotating electric machine; and a power split device splitting motive power between the reduction mechanism, the engine and the second rotating electric machine. The reduction mechanism has a reduction gear ratio of at least two to one between the first rotating electric machine and the power split device.

Preferably, a rotational shaft of the engine as well as respective rotational shafts of the first rotating electric machine and the second rotating electric machine rotate about the same axis.

More preferably, the power split device is a planetary gear set connected to the reduction mechanism, the engine and the second rotating electric machine. The reduction mechanism is a gear mechanism on which one rotational element of a planetary gear set is fixed.

In accordance with the present invention, a vehicle drive apparatus can be implemented with which both of iron-loss reduction and enhancement of the rotor-core strength can be achieved and high-speed rotations can be achieved with improved energy efficiency.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a cross-sectional view showing a structure of a vehicle drive apparatus of a hybrid vehicle according to an embodiment of the present invention.

FIG. 2 is a schematic showing in detail a power split device PSD and a reduction mechanism RD in FIG. 1.

FIG. 3 shows a change in motor characteristics caused by incorporating reduction mechanism RD shown in FIG. 2.

FIG. 4 shows a cross-sectional shape of a stator 43 and a rotor 42 of a motor generator MG2.

FIG. 5 shows vector potential contour lines in the case where eight poles are provided.

FIG. 6 shows a change in total harmonic distortion THD with respect to wave width θ.

FIG. 7 shows a bridge portion modeled with beam elements.

FIG. 8 shows a change in maximum stress in the case where the number of bridges is varied from two to five.

FIG. 9 shows a relation between the stator's outer diameter and the rotational speed rpm of a motor that has been developed as a vehicle motor.

FIG. 10 illustrates distribution of major motor losses.

### BEST MODES FOR CARRYING OUT THE INVENTION

The present invention is hereinafter described in detail with reference to the drawings. In the following, like or corresponding components are denoted by like reference characters and a description thereof is not repeated.

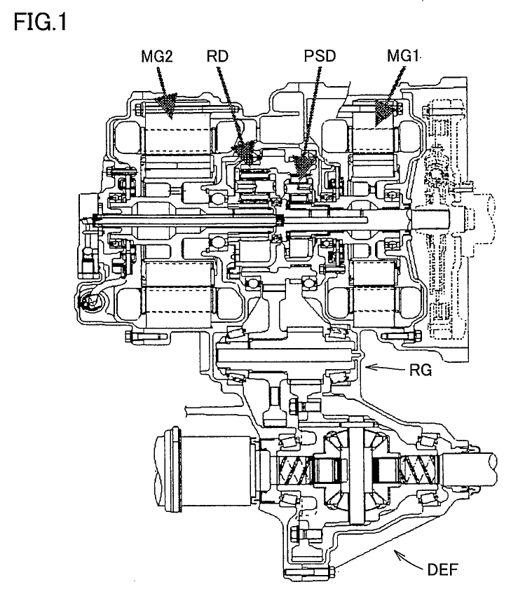

FIG. 1 is a cross-sectional view showing a structure of a vehicle drive apparatus of a hybrid vehicle according to an embodiment of the present invention.

Referring to FIG. 1, the vehicle drive apparatus includes motor generators MG1, MG2, a power split device PSD, a reduction mechanism RD, a reduction gear RG, and a differential gear DEF.

As shown in the cross section of FIG. 1, such components as motor generator MG2 operating chiefly as a motor for driving wheels, motor generator MG1 operating chiefly as an electric generator and power split device PSD are arranged on the same axis as that of an engine (not shown) so as to decrease in size and lower the center of gravity of the vehicle drive apparatus unit.

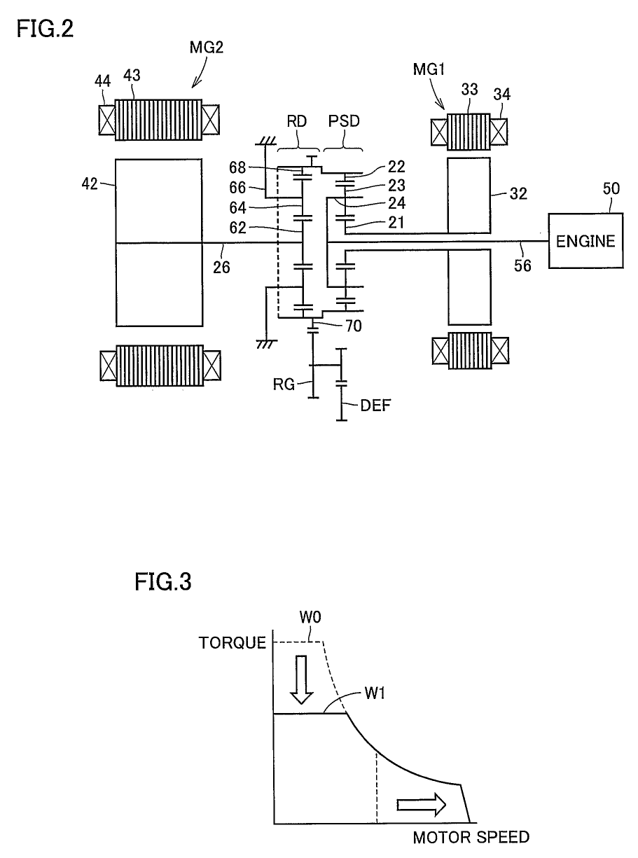

FIG. 2 is a schematic showing in detail power split device PSD and reduction mechanism RD in FIG. 1.

Referring to FIG. 2, the vehicle drive apparatus has motor generator MG2, reduction mechanism RD connected to the rotational shaft of motor generator MG2, an axle rotating according to rotations of the rotational shaft reduced in speed by reduction mechanism RD, engine 50, motor generator MG1, and power split device PSD dividing power between reduction mechanism RD, engine 50 and motor generator MG1. Reduction mechanism RD has its reduction gear ratio between motor generator MG2 and power split device PSD of at least two to one.

The rotational shaft of engine 50 and respective rotational shafts of motor generator MG1 and motor generator MG2 rotate on the same axis.

Power split device PSD is a planetary gear set including a sun gear 21 coupled to a hollow sun gear shaft with its shaft center through which a crankshaft 56 passes, a ring gear 22 supported rotatably on the same axis as that of crankshaft 56, pinion gears 23 provided between sun gear 21 and ring gear 22 and rotating around sun gear 21 while rotating on their own axes, and a planetary carrier 24 coupled to an end of crankshaft 56 and supporting the rotational shaft of each pinion gear 23.

Power split device PSD has three power input/output shafts, namely the sun gear shaft coupled to sun gear 21, a ring gear casing coupled to ring gear 22 and crankshaft 56 coupled to planetary carrier 24. When the power input/output to two of the three shafts is determined, the power input/output to the remaining one shaft is determined based on the power input/output to the two shafts.

A power take off gear 70 for taking off motive power is provided on the outside of the ring gear casing to rotate together with ring gear 22. Power take off gear 70 is connected to a power transmission reduction gear RG. Motive power is thus transmitted between power take off gear 70 and power transmission reduction gear RG. Power transmission reduction gear RG drives differential gear DEF. On a downhill for example, rotations of wheels are transmitted to differential gear DEF and power transmission reduction gear RG is driven by differential gear DEF.

Motor generator MG1 includes a rotor 32 having a plurality of permanent magnets arranged therein as well as a stator 33 having a three-phase coil 34 wound therearound for generating a rotating magnetic field. Rotor 32 is coupled to the sun gear shaft that rotates together with sun gear 21 of power split device PSD. Stator 33 is formed by stacking thin electromagnetic steel plates on each other and secured to a casing (not shown).

Motor generator MG1 operates as an electric motor that rotationally drives rotor 32 by interaction between magnetic fields generated by the permanent magnets embedded in rotor 32 and magnetic fields generated by three-phase coil 34. Motor generator MG1 also operates as an electric generator that causes electromotive force on both ends of three-phase coil 34 by interaction between magnetic fields generated by the permanent magnets and rotations of rotor 32.

Motor generator MG2 includes a rotor 42 having a plurality of permanent magnets embedded therein and a stator 43 having a three-phase coil 44 wound therearound for generating a rotating magnetic field.

Rotor 42 is coupled by reduction mechanism RD to the ring gear casing that rotates together with ring gear 22 of power split device PSD. Stator 43 is formed by stacking thin electromagnetic steel plates on each other and secured to a casing (not shown).

Motor generator MG2 also operates as an electric generator that causes electromotive force on both ends of three-phase coil 44 by interaction between magnetic fields generated by the permanent magnets and rotations of rotor 42. Further, motor generator MG2 operates as an electric motor that rotationally drives rotor 42 by interaction between magnetic fields generated by the permanent magnets and magnetic fields generated by three-phase coil 44.

Reduction mechanism RD reduces the speed by the structure having a planetary carrier 66, which is one of rotational elements of a planetary gear set, secured to the casing of the vehicle drive apparatus. More specifically, reduction mechanism RD includes a sun gear 62 coupled to the shaft of rotor 42, a ring gear 68 rotating together with ring gear 22, and pinion gears 64 meshing with ring gear 68 and sun gear 62 to transmit rotations of sun gear 62 to ring gear 68.

The number of teeth of ring gear 68 can be at least twice as large as that of sun gear 62 to allow the reduction gear ratio to be at least two to one.

FIG. 3 illustrates a change in motor characteristics caused in the case where reduction mechanism RD shown in FIG. 2 is incorporated.

Referring to FIGS. 2 and 3, by incorporating the reduction mechanism providing the reduction gear ratio of at least two to one with respect to motor generator MG2, the motor torque can be a half or less of a required axle torque. Thus, the physical size of the motor can be reduced.

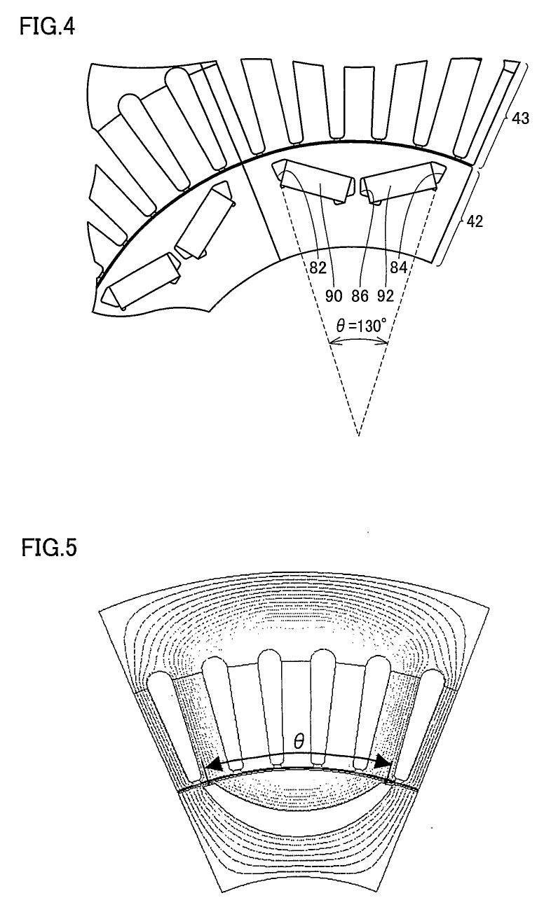

FIG. 4 shows a cross-sectional shape of stator 43 and rotor 42 of motor generator MG2.

Referring to FIG. 4, rotor 42 is formed by stacking electromagnetic steel plates and each electromagnetic still plate has openings 82, 84 for housing respective permanent magnets 90, 92.

Magnets 90, 92 are arranged within an electrical angle of 130° with its center located at the center of rotations of rotor 42. This angle is included in the range of 124° to 143.5° where TED is 30% or less and in the range of 127° to 140° where THD is 29.5% or less, which is described hereinlater.

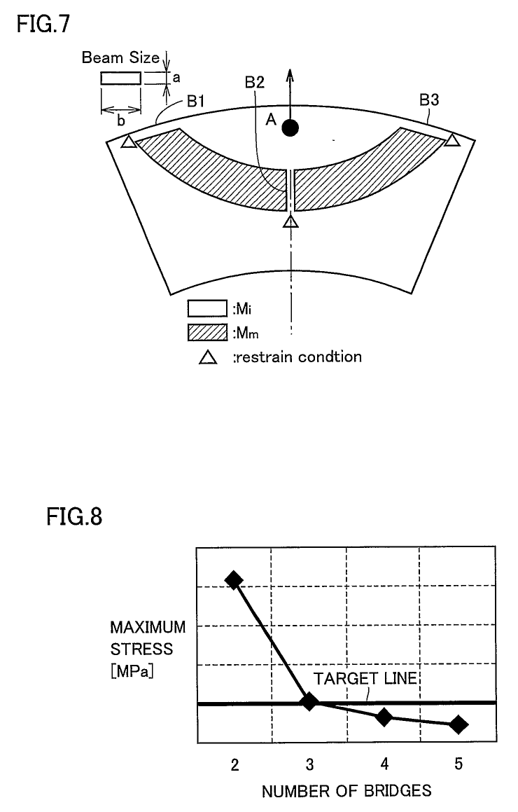

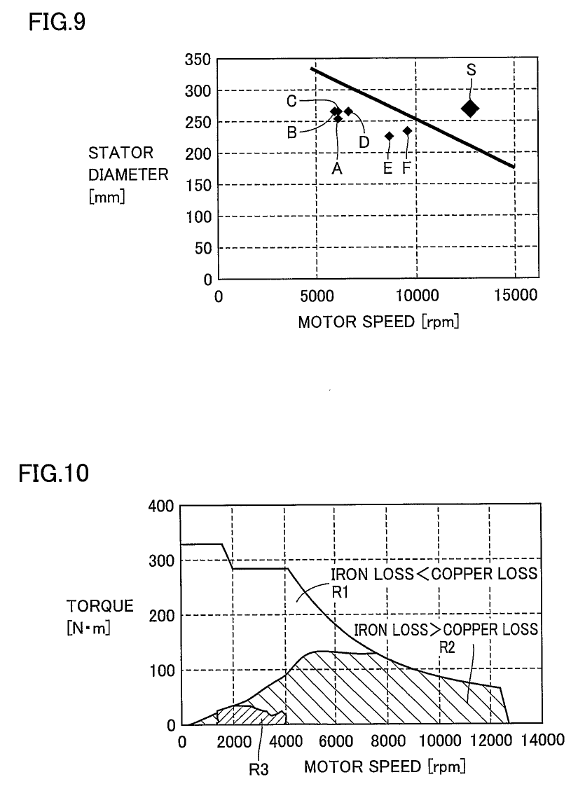

Further, magnets 90, 92 are arranged in the shape of V with its bottom, namely acute end facing toward the center of rotations. The electromagnetic plates with which rotor 42 is structured have a support portion 86 located at the acute end of the V-shape and serving as a partition between openings 82 and 84. It is noted that the shape of V or V-shape herein refers to a tapering shape or a shape diminishing gradually toward an end. It is thus herein intended that the arrangement of magnets in the V-shape includes an arrangement of magnets along a somewhat curved V-shape as shown in FIG. 7 which is described hereinlater. In the following, how to design the shape of the rotor is described.

For the drive motor rotated at high speed in order to enhance the output power density, it is required to (1) improve the rotor strength, (2) reduce iron loss and (3) effectively use the reluctance torque. Therefore, these three factors are used as important indices for evaluation. As to the number of poles, while it is desirable to have a large number of poles in terms of rotor strength and reduction of magnet volume, an increase in iron loss is an issue to be addressed. Here, in consideration of compatibility with conventional tried-and-true systems, eight poles were selected to conduct an analysis as detailed below.

[Analysis of Arrangement of Embedded Magnets]

It is well known that the torque of an IPM motor is represented by the following expression (1):

T=Pₙφₘi_{q}+Pₙ(L_{d}−L_{q})i_{d}i_{q} (1)

where T is torque, P₀ is the number of poles, φₘ is armature flux linkage by permanent magnets, I_{d} and I_{q} are respectively d-axis current and q-axis current, and L_{d} and L_{q} are respectively d-axis inductance and q-axis inductance. Further, the first term and the second term on the right side of expression (1) are respectively magnet torque and reluctance torque.

If an induced voltage of the motor is excessively large in a high-speed vehicle running state, the issue of the withstand-voltage limit has to be addressed. Therefore, in view of this, φₘ has to be determined. In other words, in order to increase torque T, it is necessary that φₘ of the magnet torque in the first term on the right side of expression (1) is not excessively increased while the reluctance torque in the second term on the right side thereof is effectively used.

In the second term on the right side of expression (1), i_{d} has a negative value. Therefore, an IPM structure improving the reluctance torque is a structure maximizing L_{q} while minimizing L_{d}. In other words, the structure with improved reluctance torque allows the q-axis magnetic flux to pass most easily and allows the d-axis magnetic flux to pass least easily.

The direction in which the q-axis magnetic flux passes most easily is the direction in which vector potential contour lines (lines of magnetic induction) pass in the case where the rotor is entirely made of iron and q-axis current is allowed to flow. Therefore, an IPM structure having a maximum q-axis inductance L_{q} is a structure having magnets arranged in the flux barriers provided along the vector potential contour lines.

It has also been proposed to provide a multi-flux barrier structure having many layers of flux barriers to obtain a large reluctance torque. However, in a structure having two or more layers of flux barriers, embedded magnets are thinner which considerably increases the cost for magnets due to processing for the thinner magnets. Therefore, the analysis was conducted using a single flux barrier layer.

FIG. 5 shows vector potential contour lines in the case where eight poles are employed. Even if magnets are arranged along the vector potential contour lines, there may be some arbitrary shapes of the arrangement depending on selection of the magnet opening angle θ shown in FIG. 5. Thus, it is then necessary to determine θ.

Although it is desirable to have a large magnet-opening angle for improvement of the magnet torque, the angle is desirably smaller for reduction in iron loss and no-load induced voltage. In other words, magnet opening angle θ has an optimum value.

The optimum value of 0 to be selected varies depending on what elements are important for an intended purpose. In the present embodiment, with the purpose of reducing harmonic components of iron loss, magnet opening angle θ is selected. Although waveforms of air gap flux density distribution determined by calculation are different in amplitude depending on the shape in which the magnets are embedded, respective widths of the waveforms are substantially the same. The waveforms are each rectangular in shape that is determined by magnet opening angle θ.

The waveform of the magnetic flux density distribution is approximated to a rectangular wave having the wave width corresponding to magnet opening angle θ and the total harmonic distribution THD representing the ratio of the fundamental component is determined as a function of θ as shown below.

$$\begin{matrix}THD = harmonic amplitudes of respective orders / \\ fundamental amplitude \times 100 \\ = ( √ ( rectangular wave ' s effective {value}^{2} - \\ fundamental ' s effective {value}^{2} ) ) / \\ fundamental ' s effective value \\ = ( √ ( ( √ {( θ / π )}^{2} - {( 1 / √ 2 \times 4 / π \times sin ( θ / 2 ) )}^{2} ) ) / \\ ( 1 / √ 2 \times 4 / π \times sin ( θ / 2 ) ) \\ = ( √ ( 2 \times {π}^{2} / {4}^{2} \times ( θ / π - 1 / 2 \times {4}^{2} / {π}^{2} \times {sin}^{2} ( θ / 2 ) ) ) ) / \\ ( sin ( θ / 2 ) )\end{matrix}$$

Accordingly, the finally determined total harmonic distortion THD (%) is represented by the following expression:

THD=(√(πθ/8−sin²(θ/2))/(sin(θ/2)) (2)

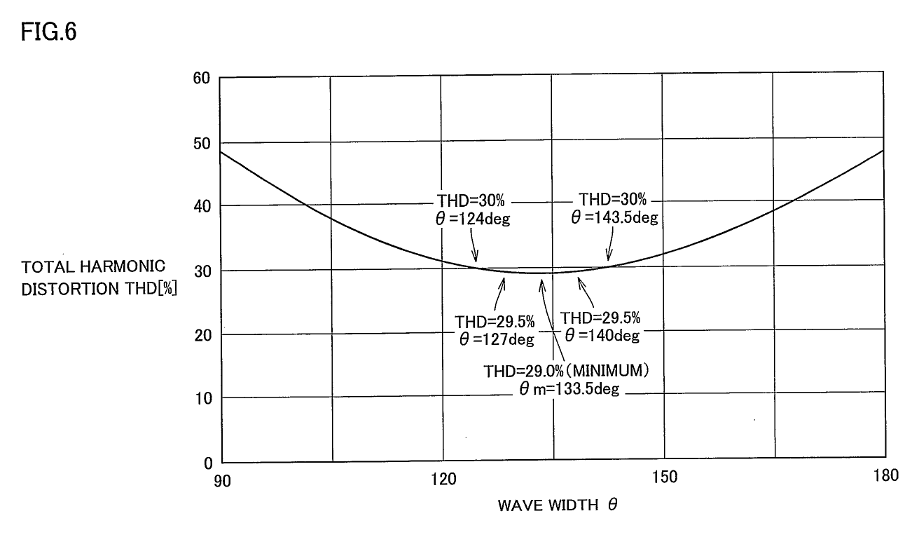

FIG. 6 shows a change in total harmonic distortion THD with respect to wave width θ.

As shown in FIG. 6, the minimum THD 29% is obtained when wave width θ is 133.5° (θ=133.5°). Since the harmonic of the magnetic flux waveform increases the harmonic component of no-load iron loss, THD is preferably smaller in terms of reduction in iron loss. Ideally, magnet opening angle θ may be 133.5° in order to have the minimum THD.

Actually, it is desirable to design angle θ to be appropriately large for improving the torque among other elements to be improved by design. In contrast, for improving the strength among other elements to be improved, it is desirable to design θ to be appropriately small. Therefore, magnet opening angle θ has to be determined within a range that does not excessively increase THD. In view of the above-described requirements, an appropriate numerical value of THD should be 30% or lower. More preferably, THD should be 29.5% or lower. In other words, magnet opening angle θ may be within the range of 124° to 143.5° (θ=124°−143.5°) where THD is 30% or lower. More preferably, magnet opening angle θ may be within the range of 127° to 140° (θ=127°−140°) where THD is 29.5% or lower.

[Analysis of Bridge Structure]

For the IPM motor, in order to ensure a satisfactory rotor strength, a bridge is necessary for the flux barrier portion in which magnets are inserted. However, the presence of the bridge increases the magnet flux leakage. Therefore, it is desirable to have a bridge width and a bridge number that are minimum to the extent that the satisfactory rotor strength is ensured.

FIG. 7 shows a bridge portion modeled with beam elements.

In FIG. 7, three bridges B11, B2 and B3 are shown that are used for model analysis. In this model, the magnet is provided in one layer along the vector potential contour lines in FIG. 5 at an electrical opening angle of approximately θm. The bottom end of the beam indicated by the triangular symbol in FIG. 7 is completely restrained. In this state, it is supposed that the centrifugal force corresponding to mass M=Mm+Mi, which is determined by adding together the magnet mass Mm and the iron-core mass of the upper portion of the magnet Mi, is exerted on the point A of the center of mass in the outward direction with respect to the center of rotations of the rotor, so that each beam is pulled. In FIG. 7, “a” and “b” represent the width and length of the beam respectively.

FIG. 8 shows a change in maximum stress in the case where the number of bridges is varied from 2 to 5.

The data shown in FIG. 8 is obtained using a certain fixed width “a” and a certain fixed length “b” of the beam. The target line in FIG. 8 is a line determined by the yield stress of the material, indicating a value predicted to satisfy stress conditions in consideration of the final shape or the manufacturing process. As shown in FIG. 8, it is seen that the bride number increased from 2 to 3 remarkably mitigates the maximum stress.

As to the magnet torque depending on the number of bridges, an increased bridge number increases the flux leakage in the rotor and thus disadvantageous. Here, under a fixed stator condition, the calculated effective utilization ratio of flux linkages φm decreases like 96%, 92%, 87%, 82% corresponding respectively to the bridge number 2, 3, 4, 5.

Here, the analysis is also conducted in terms of the reluctance torque. While q-axis inductance L_{q} does not change, d-axis inductance L_{d} increases as magnetic paths in the d-axis direction increase. For the bridge number 2, 3, 4, 5, the value determined by calculating L_{q}−L_{d} decreases as 1.546, 1.373, 1.291, 1.208 (mH) respectively. Since I_{d} in the second term of expression (1) is negative, a decrease of the value determined by L_{q}−L_{d} causes the reluctance torque to decrease as well.

Accordingly, for both of the magnet torque and the reluctance torque, it is not preferred to increase the bridge number from 3 to 4 or 5.

Then, in order to determine whether the bridge number should be 2 or 3, calculation was newly performed for a model with two bridges with the bridge width “a” increased until the stress is equal to the target value or smaller is reached.

It was accordingly found that, while the original model with the three bridges provides the effective utilization ratio of magnetic flux φm of 92%, the effective utilization ratio decreases to 86% in the case where the bridge width “a” is increased and the bridge number is 2. As to the calculated value of L_{q}−L_{d}, while the calculated value for the original three-bridge model was 1.373, the calculated value decreases to 1.194 (mH) in the case where the bridge width “a” is increased and the number of bridges is 2. Thus, it is determined that a three-bridge structure is employed as a rotor structure with which the magnetic flux and reluctance torque per unit volume can most effectively be utilized.

In this way, the rotor shown in FIG. 4 is designed and improvements in material for example are further made. Accordingly, required output characteristics are satisfied while the torque density is improved, and no-load loss can be reduced by at least 30%. Of the reduction of 30%, the effect obtained by the improvement in reluctance torque and reduction in harmonic loss is considered to be approximately 10%.

As heretofore discussed, according to the present embodiment, the magnet opening angle is set to a value with which the harmonic ratio is low and bridges are provided between magnets to enhance the rotor strength, thereby achieving both of the reduction in iron loss and the improvement in rotor core strength. Accordingly, a vehicle drive apparatus can be achieved that can implement high-speed rotations with improved energy efficiency.

Although the present invention has been described and illustrated in detail, it is clearly understood that the same is by way of illustration and example only and is not to be taken by way of limitation, the spirit and scope of the present invention being limited only by the terms of the appended claims.

1. A rotor of a rotating electric machine, comprising:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having a support portion placed at the acute end of said V-shape and serving as a partition between said first opening and said second opening.

2. The rotor of the rotating electric machine according to claim 1, wherein
said rotor is a rotor of an eight-pole interior-magnet synchronous rotating electric machine.

3. A rotating electric machine, comprising:
a stator; and
a rotor,
said rotor including:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having a support portion placed at the acute end of said V-shape and serving as a partition between said first opening and said second opening.

4. The rotating electric machine according to claim 3, wherein
said rotating electric machine is an eight-pole interior-magnet synchronous rotating electric machine.

5. A vehicle drive apparatus, comprising:
a first rotating electric machine;
a reduction mechanism connected to a rotational shaft of said first rotating electric machine; and
an axle rotating according to rotations of the rotational shaft reduced in speed by said reduction mechanism,
said first rotating electric machine including:
a stator; and
a rotor, and
said rotor including:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having a support portion placed at the acute end of said V-shape and serving as a partition between said first opening and said second opening.

6. The vehicle drive apparatus according to claim 5, further comprising:
an engine;
a second rotating electric machine; and
a power split device splitting motive power between said reduction mechanism, said engine and said second rotating electric machine, wherein
said reduction mechanism having a reduction gear ratio of at least two to one between said first rotating electric machine and said power split device.

7. The vehicle drive apparatus according to claim 6, wherein
a rotational shaft of said engine as well as respective rotational shafts of said first rotating electric machine and said second rotating electric machine rotate about the same axis.

8. The vehicle drive apparatus according to claim 7, wherein
said power split device is a planetary gear set connected to said reduction mechanism, said engine and said second rotating electric machine, and
said reduction mechanism is a gear mechanism on which one rotational element of a planetary gear set is fixed.

9. A vehicle drive apparatus, comprising:
a first rotating electric machine;
a reduction mechanism connected to a rotational shaft of said first rotating electric machine;
an axle rotating according to rotations of the rotational shaft reduced in speed by said reduction mechanism;
an engine;
a second rotating electric machine; and
a power split device splitting motive power between said reduction mechanism, said engine and said second rotating electric machine,
said reduction mechanism having a reduction gear ratio of at least two to one between said first rotating electric machine and said power split device.

10. The vehicle drive apparatus according to claim 9, wherein
a rotational shaft of said engine as well as respective rotational shafts of said first rotating electric machine and said second rotating electric machine rotate about the same axis.

11. The vehicle drive apparatus according to claim 10, wherein
said power split device is a planetary gear set connected to said reduction mechanism, said engine and said second rotating electric machine, and
said reduction mechanism is a gear mechanism on which one rotational element of a planetary gear set is fixed.

12. A rotor of a rotating electric machine, comprising:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having support means placed at the acute end of said V-shape for serving as a partition between said first opening and said second opening.

13. A rotating electric machine, comprising:
a stator; and
a rotor,
said rotor including:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having support means placed at the acute end of said V-shape for serving as a partition between said first opening and said second opening.

14. A vehicle drive apparatus, comprising:
a first rotating electric machine;
a reduction mechanism connected to a rotational shaft of said first rotating electric machine; and
an axle rotating according to rotations of the rotational shaft reduced in speed by said reduction mechanism,
said first rotating electric machine including:
a stator; and
a rotor, and
said rotor including:
a first magnet and a second magnet arranged within an electrical angle in the range of 127° to 140°, the electrical angle having its center at the center of rotations of the rotor, and said magnets being arranged along a V-shape with its acute end facing toward the center of rotations; and
a rotor body having a first opening and a second opening housing said first magnet and said second magnet respectively, said rotor body having support means placed at the acute end of said V-shape for serving as a partition between said first opening and said second opening.
